(19) United States
(12) Patent Application Publication
(10) Pub. No.: US 2009/0095159 A1
(43) Pub. Date: Apr. 16, 2009

(54) Dimensionally stabilized particulate protective fabric

(76) Inventor: Joel D. Martz, Lawrence, NY (US)

Correspondence Address: David M. Warren, 655 Oakland Ave., Cedarhurst, NY, 11516, US

(21) Appl. No.: 12/287,602

(22) Filed: Oct. 10, 2008

Related U.S. Application Data
(60) Provisional application No. 60/998,833, filed on Oct. 12, 2007.

(51) Int. Cl. B01D 39/14; B01D 39/18; B01D 53/22

(52) U.S. Cl. 96/11; 55/527; 55/528; 55/524

(57) ABSTRACT

A fine particle filtration fabric, stabilized dimensionally against distension by a force field which may be applied to the fabric, has a layer of air filtration media, and a reinforcing matrix of filaments extending linearly in plural directions within a two-dimensional geometric pattern along said layer of filtration media or even outside of a composite fabric containing filtration media to inhibit the distension. The air filtration media comprises a layer of flexible lay-down of discontinuous filaments or fibers providing interstitial spacing in a range of 0.1 to 0.5 microns, the layer having a thickness in the range of 1-5 millimeters.

### RELATED APPLICATION

This application is based on and claims right of priority in a provisional patent application having Application No. 60/998,833 filed Oct. 12, 2007 by Joel D. Martz, the disclosure of which is incorporated herein in its entirety.

### FIELD OF THE INVENTION

This invention relates to a fabric having filtration properties.

### BACKGROUND OF THE INVENTION

Filtration can be defined as the separation of one material from another. Therefore, filtration is basically a process of separation.

The most simplistic approach to air filtration is to create an interception screen which removes particles by screening where fine fibers or filaments are laid down in mostly a two dimensional plane where particles to be removed take place much like a screen. The particles from the air flow are literally blocked from passage through available open pores.

This screening method is highly effective when the sizes of the particles are large in comparison to the dimension of the screen's solid blocking structure. The visual analogy for this mechanism may be imagined as the tennis racket. Thus: “The Tennis Racket Analogy”. In such a case, simple physical interception, like the ball, occurs.

It is important to frame the relative size of particles which are a challenge or physiologically harmful (about 0.3 microns) and understand this size relationship in one's mind. The language of filtration science for size measurement is to measure particles as whole multiples or fractions of microns.

A micron is 1,000,000^{th} of a meter . . . or . . . 1/24,500^{th} of an inch. A human hair is about 50-80 microns . . . and . . . the unaided human eye can see down to about 40 microns. The typical mold spore is in the range of tens of microns and bacteria are down as low as 0.2-0.3 microns.

It is down to the range of 0.3 micron where our concerns lie for protection of the human body against harmful industrial and naturally occurring harmful particulate matter.

Until now, the design of Industrial Protective Garments other than calendared polyolefin fabrics offered to the market for particulate protection have centered upon physically blocking particles or by some unspecified target and random and a not carefully standardized or equilibrated placement of fibrous material which does not target a specific removal rating, such as an assured >95% of 0.3 micron particles, as in the accepted Occupational Safety Standard in Respiratory Face Masks.

One effective method of creating an Industrial Particulate Protective garment is to employ a microporous membrane, with a nominal pore size of about 0.2 micron, to assure meaningful particulate blockage and protection. The drawback to this system is that although particle removal is achieved, far less than optimal comfort is afforded the worker since only outward moisture vapor transmission is available and practically no comfort is achieved by meaningful air transmission through the fabric.

### SUMMARY OF THE INVENTION

Therefore, this written presentation describes a novel design for the optimal fabric and garment for worker safety and comfort for particulate protection which is achieved in this new fabric especially providing dimensional stability where fabric stress is anticipated:
where particles are captured down to a physiologically significant level of 0.3 microns by a more sophisticated further filtration medium inclusive of methods such as Inertial Deposition, Random Diffusion and Electrostatic Deposition in addition to mainly Interception as in a calendared two dimensional polyolefin filamentary structure,
where air circulation and air transfer through the fabric occurs in copious amounts,
where such fabric is very light weight, typically in the range of about 50 grams per square meter or less,
where sweat is wicked away from the skin surface by hydrophobic and/or hydrophilic very fine filaments or suitable inner coating,
where a target objective of such a particle removal is assured to a level equal to or better than the 95% minimal removal rating similar to the removal of 0.3 micron particles as measured by the same test method used to test Respiratory Filters such as by a TSI 9130 Test Device,
which has an outer tough polymer surface on the top outward facing layer ideally in proximity to the filtration medium to provide total fabric and filter abrasion resistance, stability and anchorage and helps to maintain a retention rating protected from stress and distension by physical forces from outside and above that could negatively effect the set fixed positioning of the fine filaments that assure the filtration rating and which could additionally be negatively influenced by worker body movements,
such fabric should contain a scrim for dimensional protection of specifically chosen from very thin but strong leno woven or cross-laid yarns to allow for a highly drapeable fabric of filaments or yarns created by leno weave technique or adhesive fixed cross-laid nonwoven yarns or filaments fixed in position to assure a fixed open design in this scrim pattern to provide for assured copious air circulation and a maintained relationship for bonding for the filtration medium, which, affixed to the filtration medium, also provides dimensional stability and reasonably maintains filtration rating regardless of worker movement and where the majority of the multi-directional strength of the fabric as measured by standard textile methods is derived from this internal scrim.
Where it is recognized that if one attempts to stabilize a filtration medium with a regular nonwoven fabric instead of such a scrim design with a continuous close proximity fibrous structure as in typical nonwoven and woven textile design with a thick fabric for strength, air circulation would be diminished but worse, a nonwoven of such dimensional stability and resultant added weight would significantly add to an insulative effect and contribute to worker heat stress, therefore,
a scrim of strong individual filaments or yarns, thinner and at least as strong as the many fibrous filaments of a standard thicker and heavier nonwoven fabric is created and employed, where the first plurality of said strong individually thicker and stronger filaments or yarns is chosen to afford sufficient dimensional stability and intersect a similar second plurality of said filaments to form cells with uniform cell structure within said matrix, a minimum cross-sectional dimension of an individual one of said cells being greater by at least approximately an order of magnitude than a diameter of one of said filaments to provide open areas of said layer of breathable material are free from obstruction by said reinforcing filaments but with a totally stable fabric has great composite strength and dimensional stability.
The scrim structure above further acts to stabilize the filtration fibers from distension or movement in relationship to each other of the lay down of fibers to maintain the desired filtration rating. This is assured by fixing the scrim fibers by either capturing them within the layers of the composite which becomes such a filtration fabric or by self adhesive fixation which can be activated when the possible thermoplastic adhesive of the scrim in fabric is laminated by heat and pressure into a composite fabric.
Such a fabric should contain either an additional nonwoven layer to further fix the filtration fibers on its adjacent side or where the skin contact side of the filtration composite fabric stated above can be fixed in place by coating or spraying a fiber fixation polymer system.
The function of this skin contact nonwoven layer adjacent to the skin further acts to prevent the possibility of friability or mechanical degradation of the filtration medium by rubbing by contact with the skin when in use during use for protection. Further, such an intact nonwoven layer or polymeric coating can act to help wicking of sweat away from the skin.
The foregoing product description precisely defines this new concept in Industrial and General Use Particulate and Non-liquid Garment Protection. Commercially, it will be called, “The” Body Filter”™ Industrial Protective Garment, “. . . the first standardized and calibrated garment filtration system . . . ”

### DETAILED DESCRIPTION OF THE INVENTION

The creation of the objectives stated above requires an understanding of filtration and nonwovens science and a practical understanding of in-use dynamics and stresses the protective fabric will see under normal in-use conditions.

Joel Martz, U.S. Pat. No. 5,656,167, has taught the function of Dimensional Stabilization of Breathable Membranes from wear and use stresses of fabrics in garments and that dimensional stresses of these protective membranes can be altered by such stress and that the maintenance of removal ratings of monolithic and microporous membranes which can be further assured by stabilization of the membrane from such stresses by multidirectional fixed filament stabilization by adhesive cross laid manufacture or leno weave, generically described in the patent and here as scrim. This use of the word scrim is not to be confused with continuous spun bonded or similar nonwoven fabrics also sometimes also called a scrim.

In order to understand the significance of the stabilization by the above Dimensional Stabilization method for the filtration fibers of such a fabric for standardized and calibrated garment filtration systems, a few words should be said about the mechanisms of particle retention and capture which is provided by these filtration mechanisms and why fiber stability in maintenance of placement relative in close proximity to each other is so critical. This concept being the heart of the significance of the special added benefit of Dimensional Stabilization described in The Martz Patent for Membrane Technology and why it is as relevant to maintenance of air filtration efficiency of removal ratings as described above.

Until now, the most successful commercial products in The Industrial Protective Garments Market for particle protection are based primarily on the concept of physically blocking particles from passing through apertures or tortuous paths which are smaller than the typical particle size of 0.3 microns which is considered to be “dangerous”. One approach to this need is found when microporous membranes are applied as the pore defining block for the intended “dangerous” particle. We may certainly determine that with proper lamination or stability applied to the membrane a reliable fixed pore size can be assured. This allows for a reproducible filtration rating. Certainly, the typical pore size of such typical microporous membranes which achieve this physical interception, are sub-micron in size. This size is typically measured as a mean pore size in the range of 0.22 microns.

In this membrane model, although this fabric system can offer outward moisture transmission, best worker comfort to minimize the possibility of creating physiologically damaging Heat Stress is achieved only when sweat is copiously wicked away from the skin surface and is most importantly, also coupled with air flow which circulates and allows massive thru-fabric air transmission as well.

It is important to note that researchers in The Physiology of Human Comfort have determined seven major factors that determine thermal comfort:
1. Air (dry bulb) temperature
2. Humidity
3. Mean Radiant Temperature
4. Air Movement
5. Clothing weight and insulative capacity
6. Activity level
7. Rate of change of any of the above.

It is plainly evident that such a microporous system in a fabric has limited outward moisture transmission and especially due to the small pore size, and hence meaningless outward air movement and circulation.

It has been previously mentioned that a textile product was designed and successfully accomplishes such a fixed pore size in another way by an extrusion spinning process where the lay down of the numerous fine filaments in a controlled but random pattern is so controlled to create such small pore size, capable of primarily blockage of the intended 0.3 micron particles by physical interception. This can be called the “The Tennis Racket Analogy” or the creation of a plastic fabric model which is functionally similar to a plastic bag with minute “bacteria and mold sized” pores. Obviously air passage is poor or nonexistent. Heat Stress can therefore be a significant danger.

In such creating the above fabric system, it was clearly understood that stabilization from movement of these laid down fine plastic filaments relative to other adjacent filaments must be achieved. Therefore, in order to prevent such fiber movement, the entire fabric is calendared so that these thermoplastic filaments, made from a polymer such as polyethylene, are bonded to each other and are fixed.

As a result of the calendaring process, the filaments become rather smooth and relatively non-fibrous and the resultant fabric is noted to be smooth and poorly capable of wicking sweat away from the skin. Although some significant moisture elimination takes place, comfort is universally recognized as poor since air circulation and thru-fabric movement is negligible and insignificant in normal wearing.

Although such a fabric has existed for decades, and worker discomfort is talked about, now, with advances in textile technology, coupled with new fiber and chemical technology with added advances in electrostatic fiber charging technology, new fine fiber lay down technology affords the opportunity for a new generation in fine fiber particle protective fabrics.

New nonwoven technology in fine compacted fiber melt blown technology is particularly suitable for such a garment filtration media because of their inner complicated structures. The main objective of this newer type of filter media is to maximize the possibility of collision and the subsequent retention of the suspended particles in the air stream within the fibrous structure while minimizing the energy loss of the stream of air.

It is important to note that a large portion of the total volume occupied by the filter is in fact air space. The ratio of the volume of air or void contained in the fabric to the total fabric fiber volume dictates the resistance to flow.

In this alternate Melt Blown Model, filtration takes place by several mechanisms inclusive of but in addition to interception which is the primary capture method of the spun filament calendared polyolefin system. In the Melt Blown Model additional highly significant capture mechanisms occur between the spaces between the individual fibers.

As will be explained, highly significant capture modes of attraction and particle removal take place which depend on the space relationship of each fine fiber to each adjacent fiber. It is precisely for that reason that the various methods described herein in this review are employed to assure this fixation and dimensional stability by inner or outer surface “scrim” dimensional stabilization as noted and by the various possibilities offered for abrasion resistance and further filtration surface stabilization on the inner and outer fabric composite.

The science of particle retention by such filtration is extremely complex physics but this brief summary will hopefully elucidate the importance of spatial fiber relationships:
1. INTERCEPTION: This has been discussed previously in describing microporous membranes and in a fabric created by spun calendaring of thermoplastic filaments. It is equally significant here too to assure the close fiber relationships of the rather physically particle blocking by loose fibers non bonded fibers as well which here achieve this interceptive objective.
2. INERTIAL DEPOSITION: Velocity of a flow increases when passing the spaces of a filter because of the continuity equation. When a heavy particle is carried by the flow of the air stream, it is thrown out of the flow streamlines due to its inertia (mass X speed). This can cause a particle to be caught by other fibers closely adjacent.
3. RANDOM DIFFUSION (BROWNIAN MOTION): Particles which are entrapped within the air flow are subject to Brownian Motion, which can be described as random vibration and movement of small particles in that flow. The particles exhibit a zigzag random movement within the filter in the openings between the anticipated measured and calculated space between the fibers which increases the chance of being caught in the filter material. It is evident that chance movement of the fibers by the stress of dimensional instability can adversely affect the filtration rating.
4. ELECTROSTATIC DEPOSITION: It is reorganized that sub-micron particles are difficult to capture even with a combination of mechanical methods. It is well known that strong electrostatic forces can be imparted to the fibers and that this charge can be made permanent. Fabric distension or deformation can cause the fibers within the filtration medium to loose their electrostatic attractions to small particles as they pass through an altered air flow path relative to the fiber spatial relationship to each other because of altered distances of fibers to air flow path causing loss of electrostatic attraction. Dimensional Stability as described in this review obviously can maintain the air path through the filter medium to achieve the required proximity to fibers for capture of particles by electrostatic attractive forces.

The above presented review sets out as its objective a goal where it is proposed that the carefully selected fiber sizing, lay down and filtration design can be achieve a Standardized and Calibrated Particle Filtration Fabric and Garment which can be created to establish a particle removal rating equal in efficiency (>95% of 0.3 micron particles) that can allow it to be compared in efficiency to a N95 Respiratory Filter.

The hypothesis being made is that the entire body can be protected from dangerous particles which are recognized to be 0.3 micron and larger. This means that a similar protection afforded to protect the lungs as per an accepted filtration rating standard (NIOSH N95) can offer similar protection to the entire body.

Obviously, once this rating is achieved and standardized and calibrated by control of manufacturing techniques, assurance must be given that stress in use and anticipated distensions are addressed, anticipated and prevented by novel Dimensional Stabilization Design features described above and herein.

The N95 Standard determines a Respiratory Filter Mask's ability to stop 95% of 0.3 micron dry particles, (NaCl), from passing through, at airflow equal to a normal lung capacity. This is pre determined as being 85 liters per minute.

The mask is placed on a TSI 8130 Testing Unit and the whole device will be tested at 85 lpm. The mask cannot exceed 5% penetration of particles over a 20 minute period. The test unit allows an option for neutralization of the charge on the NaCl particle.

Rather than testing a finished Face Mask, Niosh test procedure allows the filter media alone to be tested as a flat unincorporated fabric. If one wishes to test media alone the sample size tested is 100 cm2. The TSI unit offers an adapter to hold such a 100 cm2 sample. If the actual final mask contains 170 cm2 of media, one divides the flow (85 lpm-liters per minute) by the mask size and multiply by 100 cm2 to get the media velocity. i.e.

Mask size 170 cm2

Flow 85 lpm

85/170=0.5 lpm/cm2

Flat piece sample size =100 cm2×0.5=test flow for flat piece 50 lpm . . . therefore the particle retention for the 100 cm fabric sample at this flow rate fabric must be greater than 95% of 0.3 micron salt particles to qualify the final filter as N95.

The following is the rationale that is suggested to enable the statement that this fabric and resultant garment, “The Body Filter ”, offers a particle retention standard equivalent to a N 95 Respiratory Filter Mask for full body protection:

For the “Body Filter” we determined that normal body movement would generate approx 3 lpm. This includes the “Bellows Effect” in arm movement, walking, bending and other activities. The overall fabric consumption and surface area for an Extra Large Coverall is about 4.0 square Meters or 160,000 cm2. Assuming that only 10% of this fabric surface will be effective in the area that the flow is generated i.e. arm pits, knees etc that is still a filter area of 16,000 cm2.

This means that . . . actual flow rate per square meter is 0.0001875 L/Minute/Sq M.

3 L/16,000 sq cm=0.0001875 L/Minute/Sq M×100 cm=0.01875 L/M/Sq M

If we use the 100 cm adapter for TSI 8310 testing . . . the theoretical flow rate thru the unit should be 0.01875 L/M in. . . . BUT . . . the lowest test flow rate that can be set on the TSI 8310 is 2.3 L/minute, which is 122.7 TIMES GREATER FLOW RATE THAN THE actual projected calculated TEST FLOW RATE of 0.01875 L/Min.

Therefore, testing a 100 cm2 sample of “Body Filter” Fabric on TSI 8310 at a flow rate of 2.3 L/Minute and achieving a retention rating in excess of 95% theoretically offers an equivalency of N95 with a “Cushion Factor” based on flow rate GREATER THAN 100 TIMES.

A Test of the “Body Filter” Fabrics Manufactured starting in June, 2006 demonstrated a penetration of 0.257 percent of particles 0.3 micron as tested on TSI 8310 with a 100 cm2 fabric sample. This means that the efficiency of the “Body Filter” may be stated as far greater than 95%, or 99.743% at the flow rate of 2.3 L/Min. However, since the flow rate of 0.01875 L/Min cannot be set on the TSI 8310 and actual lowest flow rate that could be set was 2.3 L/Min, we can recalculate actual penetration percentage as 0.257/16,000 cm2=0.0002% . Therefore, the expected efficiency of “Body Filter: may be stated as 99.9998%. Therefore, stating that “Body Filter” is equivalent to a N95 Respiratory Filter Mask may be a very conservative statement.

Therefore, this novel standardized and calibrated filtration garment meets all objectives as the optimal fabric and garment to provide protection from noxious and dangerous particles and for general dry particle protective purposes. It meets the high level of particle protection similar to a device accepted to afford protection to the lungs, The NIOSH N95 Respiratory Filter. It also overcomes the extremely important objective of allowing high thru-fabric air flow and highest possible ability to achieve high outward moisture transmission far beyond anything possible with microporous membranes or calendared spun thermoplastic filaments. Finally, by its recognition and understanding of the need for dimensional stability relative to the fiber and filtration specifications and creation, it maintains the required filtration rating by offering surface and internal fixation and protection for the fiber regardless of the anticipated stresses applied to the composite and garment by its intended use.

In the construction of the air filtration fabric of the invention, the fabric is composed of a layer of air filtration material supported by a matrix of flexible filaments ensuring dimensional stability in terms of the dimensions of pores and interstitial spaces defined by fibers of the air filtration material. The air filtration media, in a preferred embodiment, comprises a layer of flexible lay-down of discontinuous filaments or fibers providing interstitial spacing in a range of 0.1 to 0.5 microns, the layer having a thickness in the range of 1-5 millimeters. This thickness is significantly smaller than an anticipated range of bending radii of the fabric in use as a drape or garment for the human body so as to avoid excessive distortion in the configurations of the interstitial spaces, while the matrix of supporting filaments prevents distension of the fabric during bending movements of a person wearing the fabric.

A test of the fabric, in accordance with an embodiment of the invention, was conducted by draping a portion of the fabric about a person's knee, and then flexing the knee to observe results of deflection of the fabric. This is an_example, by experimental validation, of enhanced maintenance of particulate filtration efficacy by the employment of dimensional stabilization by fixed filament stabilization in a light-weight particulate protective fabric from potential in-use physical fabric stresses induced during work by body movement.

A laboratory model was developed to simulate the physical stresses induced in a light-weight particulate protective fabric that employs airborne particle filtration. These stresses to the fabric can be induced by worker movement during regular activity.

An example of such a movement which can occur during labor can be exemplified by a kneeling or stooping activity, such as bending to pick up objects. Flexing of the knee is one easily visualized activity.

In order to measure the potential stress at the fabric on the knee, an elastic cord 4 mm wide that was affixed to two points on the knee of a male subject who is 72 inch tall and weighs 109.4 KG.

One point of the elastic cord was fixed immediately above (Dorsal) of the Patella and the other point of the elastic cord was fixed below on the Tubercle of the Tibia. The Tubercle is easily palpated on a subject as an easily identified physical marker.

The subject was instructed to stand erect when the elastic cord was affixed. The length of the elastic cord was measured to be, 12.60 cm. The subject was asked to stoop, as if to pick up an object on the floor. It was noted that the elastic cord elongated with this full activity and was shown upon measurement to be 15.12 cm. The measurement was done by overlaying a flexible plastic measuring tape on top of the elastic cord.

The measured elongation of the elastic cord of 2.52 cm is translated as an elongation stress that can be experienced as an extreme stress that could be induced in such a light weight fabric in the most extreme situation. Since it is also probable that excess fabric might occur in a baggy knee of a garment, it is probable that the entire elongation stress would not occur in typical protective garment use. With the same logic, it would be anticipated that some elongation stress would be experienced in the fabric and therefore in an experimental model it was considered that increments of stretch of fabric to simulate a bending knee would be induced in very small increments. A stretch increment of 1/14^{th} of an inch or 1.88 mm was chosen.

A Testing Instrument acknowledged widely in testing laboratories to measure tensile testing and induce measured tensile, compression, shear, flexure, peel, tear, cyclic bend and stretch stresses induced by Precision Testing Challenges is manufactured by Instron. An Instron Test machine was set up to induce measured incremental precision stretch in increments of 1.88 mm between the jaws which was intended to simulate the flexing stresses to mimic the stretch of the fabric at a flexing knee.

Two fabric samples were chosen. Test samples were 2.5″ wide×7.5″ long

Fabric Number One—Reinforced Fabric

Reinforced fabric with Apertured PE Film on surface, Melt Blown Filtration Media (20 gsm), Scrim Support—75d High Tensile Fibers, Cross Laid and Adhesively Bonded,Thermobonded—7×5 fibers per inch 20 GSM Thermonded PP.

Fabric Number Two—Non-Reinforced Fabric (without Scrim)

Non-Reinforced Fabric (without scrim), same Apertured PE Film on surface, Melt Blown Filtration Media (30 gsm), 17 GSM Spunbonded PP.

Measurement of penetration of 0.3 micron particles was measured by use of The TSI 8130 Test Machine which creates 0.3 Micron Particles and attempts to infuse these particles through the fabric with a measured air flow. An air flow setting of 2.3 liters per minute was chosen. This is the lowest air flow challenge that can be set on this test device.

The fabric taken from the jaws of the Instron was tested at stretch increments of 1.88 mm, 3.76 mm, 5.64 mm, 7.52 mm and 9.44 mm.

The following test results were observed on The TSI 8130 Device.

TABLE I
Fabric Number One - Scrim Reinforced fabric

| Increment | Penetration | % Change (from original) |
|---|---|---|
| 0 1.88 mm | 0.87% | 0 |
| 1 3.76 mm | 0.96% | 10 |
| 2 5.64 mm | 1.33% | 52 |
| 3 7.52 mm | 1.44% | 65 |
| 4 9.44 mm | 1.59% | 83 |

TABLE II
Fabric Number Two- Non-Reinforced Fabric (without scrim)

| Increment | Penetration | % Change (from original) |
|---|---|---|
| 0 1.88 mm | 0.031% | 0 |
| 1 3.76 mm | 0.045% | 45 |
| 2 5.64 mm | 0.060% | 93 |
| 3 7.52 mm | 0.068% | 219 |
| 4 9.44 mm | 0.167% | 538 |

The following are typical testing results derived from a test comparison of the Reinforced fabric described above inclusive of the scrim incorporated as above as compared with the leading Disposable Protective Fabric which is a Spun bond Olefin (Calendared) and known commercially as Tyvek® which is manufactured by DuPont. These test values were derived by incorporating the lightest possible combination of components that achieve excellent strength test values and particle retention rating.

TABLE III

| | TEST | | | |
|---|---|---|---|---|
| DESCRIPTION | METHOD | TiGUARD | Spunbond Olefin | |
| Strip Tensile | ASTM | 12.4/10.0 | 6.3/8.3 | lbs MD/CD |
| | D5035 | MD/CD | | |
| Work to Break | ASTM | 17.0/20.3 | 3.5/4.0 | |
| | D5035 | | | |
| Tensile Strength | ASTM | 32.4/32.8 | 15.8/21.3 | |
| | D5034 | | | |
| Trapezoid Tear | ASTM | 12.3/10.0 | 4.9/4.8 | |
| | D1117 | | | |
| Tongue Tear | ASTM | 5.1/6.2 | 3.4/3.2 | |
| | D2264 | | | |
| Ball Burst | ASTM 3787 | 32.1 | 21.5 | |

Conclusion

It is evident that the incorporation of a cross-laid scrim such as high tenacity 75d fibers or a similar functional component within a disposable light weight particulate protective fabric provides a marked improvement in percentage retention of retention ratings compared to a non-reinforced similar product.

For example, an induced stretching of the fabric as described of 9.44 mm caused a per cent change of 83% in a scrim reinforced fabric compared to 538% times change in a Non-reinforced fabric without such an internal support. This is a significant, 6.48 times difference. The far smaller per cent change resultant from use of a scrim reinforced fabric allows for a choice of a starting retention rating for the filtration media with predicable over-retention capability or predictable reserve in retention potential of critical particles to accommodate fabric stress. This equates to the opportunity to use both a lighter weight and less costly filtration media and eliminate the need to use an alternative to scrim which could be a heavier potential support nonwoven fabric.

Furthermore, the scrim inclusive product allows for the lightest possible combination of components which minimizes potential heat stress that would occur because of heat entrapment if a heavier filtration and support nonwoven would be necessitated. The lighter components allows for a more comfortable worker protective fabric with minimized heat stress. It is widely recognized that such heat stress that would result from a use of heavier filtration media and/or support fabric would cause minimized worker productivity which would result from heat entrapment from an insulative effect and poorer air passage though the fabric. This can even contribute to the danger of heat stress and even worker morbidity.

It is to be understood that the above-described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A fine particle filtration fabric, stabilized dimensionally against distension by a force field which may be applied to the fabric, comprising:
a layer of air filtration media, and a reinforcing matrix of filaments extending linearly in plural directions within a two-dimensional geometric pattern along said layer of filtration media or even outside of a composite fabric containing filtration media to inhibit said distension;
wherein a first plurality of said filaments intersect a second plurality of said filaments to form cells with uniform cell structure within said matrix, a minimum cross-sectional dimension of an individual one of said cells being greater by at least approximately an order of magnitude than a diameter of one of said filaments to provide open areas of said layer of breathable material free from obstruction by said filaments; and
wherein the air filtration media comprises a layer of flexible lay-down of discontinuous filaments or fibers providing interstitial spacing in a range of 0.1 to 0.5 microns, the layer having a thickness in the range of 1-5 millimeters.

2. A fabric according to claim 1 wherein said reinforcing filaments are of high tenacity polymers and created by a nonwoven cross laid process or by a special process especially suitable for low count per inch fabrics known as a Leno Weave.

3. A composite fabric according to claim 1 capable of achieving a removal rating tested on a TSI 8130 at a flow rate of 2.3 liters/min, 100 cm² filter area using a sodium chloride aerosol having a mean particle size of 0.3 microns with a penetration of less than 5 percent of particles 0.3 micron with air permeability (cfm) @20 PA of greater than 5 cfm as tested in accordance with ASTM D 737 and a pressure drop of less than 1 (mm water).

4. A fabric according to claim 1 wherein said reinforcing filaments are of high tenacity polymers and whose elasticity is less than 5% in elongation under force.

5. A composite fabric according to claim 1 capable of achieving a removal rating tested on a TSI 8130 at a flow rate of 2.3 liters/min, 100 cm² filter area using a sodium chloride aerosol having a mean particle size of 0.3 microns with a penetration of less than 0.50 percent of particles 0.3 micron with air permeability (cfm) @20 PA of greater than 5 cfm as tested in accordance with ASTM D 737 and a pressure drop of less than 1 (mm water). Such fabric is capable of retaining a removal rating with a penetration of less than 0.50 percent when typical stress of applied fabric elongation and perpendicular force field to fabric are applied as encountered in typical Industrial Protective Garment user applications.

6. A fabric according to claim 1 wherein said reinforcing filaments are of such a pattern so that distention of the fabric is less than 5% elongation as measured by a force applied to perpendicular the fabric.

7. A fabric according to claim 1 wherein said reinforcing matrix is embedded within said layer of filtration media.

8. A fabric according to claim 1 wherein said reinforcing matrix is fused to a surface of said layer of filtration media.

9. A fabric according to claim 1 wherein a layer of apertured film is covering and adhered to said filtration media and reinforcing matrix of filaments to further stabilize the composite and provide abrasion resistance.

10. A fabric according to claim 1 wherein a layer of a plastic coating but still retaining air flow created with random apertures created as part of a coating process or as inherent in its chemistry or lay down technique is covering and adhered to said filtration media and reinforcing matrix of filaments to further stabilize the composite and provide abrasion resistance.

11. A fabric according to claim 1 wherein a layer of non-friable nonwoven or with a layer of a plastic coating created with random apertures but still retaining air flow created as part of a coating process or as inherent in its chemistry or lay down technique is covering and adhered to said filtration media and reinforcing matrix of filaments to further stabilize the composite and provide abrasion resistance on the inside or downstream side of the filtration media.

12. A fabric according to claim 1 further comprising a layer of fibers wherein individual fibers of the layer of fibers are enveloped by or intimately bound to said filtration media.

13. A fabric according to claim 1 wherein said fibers are Cellulosic fibers.

14. A fabric according to claim 1 wherein said layer of fibers is of a plastic material.

15. A fabric according to claim 1 wherein said reinforcing matrix is embedded within said layer of filtration media.

16. A fabric according to claim 1 wherein said reinforcing matrix is in contact with said filtration material.

17. A fabric according to claim 1 wherein said reinforcing matrix connects with said fibers.

18. A fabric according to claim 1 wherein said matrix is fused to a surface of said layer of filtration media.

19. A fabric according to claim 1 wherein said filaments of said matrix are provided with a coating of adhesive and said matrix is secured adhesively to a surface of said layer of filtration media.

20. A fabric according to claim 1 wherein the filaments are adhered to or embedded on top of the outer film or stabilizing polymeric film-like coating as an abrasion resistance layer or within or under the similar bottom layer intended to protect the friable filtration media.

21. A garment comprising a fine particle filtration fabric according to claim 1 which is stabilized dimensionally against distension by a force field which may be applied to the filter media and a reinforcing matrix of filaments extending in plural directions along said layer of filtration media to inhibit said distension; and
wherein a first plurality of said filaments intersect a second plurality of said filaments to form cells with uniform cell structure within said matrix, a minimum cross-sectional dimension of an individual one of said cells being greater by at least approximately an order of magnitude than a diameter of one of said filaments to provide open areas of said layer of breathable material free from obstruction by said filaments.

22. A garment according to claim 13 further comprising a layer of fibrous nonwoven fabric in contact with a surface of said filtration media, and wherein said garment is a Fine Particle Protective Garment.

23. A garment according to claims 1 wherein at least some portion consists of stabilized filtration fabric and an apertured film a layer of apertured film is covering and adhered to said filtration media and reinforcing matrix of filaments to further stabilize the composite and provide abrasion resistance.
